(19) United States
(12) Patent Application Publication
(10) Pub. No.: US 2004/0243423 A1
(43) Pub. Date: Dec. 2, 2004

(54) Automotive collision estimate audit system

(75) Inventors: John Rix, Escondido, CA (US); Steven Siessman, San Diego, CA (US)

Correspondence Address: Mark R. Kendrick, PILLSBURY WINTHROP LLP, Suite 2800, 752 South Figueroa Street, Los Angeles, CA, 90017, US

(73) Assignee: DECISION SUPPORT SERVICES

(21) Appl. No.: 10/452,320

(22) Filed: May 30, 2003

(51) Int. Cl. G06F 17/00; G06F 17/60; G06G 7/00

(52) U.S. Cl. 705/1; 705/400

(57) ABSTRACT

A vehicle collision estimate audit system is utilized to audit repair estimates created by in-house estimators and independent appraisers. The vehicle collision estimate audit system includes a receiving module to receive a repair estimate. The vehicle collision estimate audit system includes a review engine to review the repair estimate and to generate an audited repair estimate. The vehicle collision estimate audit system includes a profile management database to house at least one profile and the one profile is associated with the repair estimate. The profile is utilized to assist in the generating of the audited repair estimate. The vehicle collision estimate audit system also includes a data release module to receive the audited repair estimate and to output the audited repair estimate.

### BACKGROUND

1. Technical Field

The invention relates generally to the auditing of vehicle collision estimates. The invention relates specifically to the auditing of vehicle collision estimates based upon business rules and statistical indices.

2. Discussion of the Related Art

Computerized estimating systems have been developed for use in the vehicle collision repair industry. These systems use parts price information and replace and refinish labor times from ADP, Mitchell International and Motor Publications to create repair estimates of vehicle collision damage. While these systems include logic to calculate refinish and repair times based on overlapping panels, their databases are based on replacing new parts on new vehicles and do not include labor times for repairing parts. Thus, these systems rely on estimator judgment for these operations.

The automotive repair industry includes the automotive repair facilities, independent adjusters or appraisers, and insurance companies. In addition, insurance companies create lists of criteria for the acceptance of estimates. For example, an insurance company may set criteria that corrosion protection can be reimbursed 0.3 hours times a body labor rate plus $7.50 in materials cost for each panel repaired or replaced. This results in the current automotive repair industry practice of insurance companies manually reviewing repair estimates and repair facilities for compliance of insurance repair policies. In addition, estimates and photographs are manually reviewed of estimates to ascertain the correctness of estimates for repair content against the vehicle damage. Finally, estimates are manually reviewed to identify missing repair operations and to identify repair operations which should not be on the estimate.

Repair facilities, insurance companies, or the independent adjusters/appraisers may generate a repair estimate. The repair estimate would then be sent to the insurance company for approval. If the insurance company approved the estimate, the repair facility could complete the necessary repair work. Once the work was completed, the repair facility could request payment from the insurance company or any other payment provider. In the past, the automotive repair industry was a paper-intensive system.

However, the automation of the automotive repair industry is increasing. A number of companies have developed estimating software packages to assist an auto repair shop operator in automating the automotive repair estimate. These packages enable an auto repair shop operator to efficiently run their business. In some cases, companies have developed a computerized system to transmit a generated estimate to a payment provider, such as an insurance company.

Even with the automation of the estimating process, the efficiency of the automotive repair industry is lacking. Because one estimating software package is not the standard in the industry, repair facilities and independent appraisers/adjusters utilize one of many available products. This may lead to unfamiliarity with some of the estimates being generated by the estimating system. This may lead to mistakes and delays.

In addition, because personnel must enter the data into the estimating packages, there is always a possibility for incorrect information being entered or for certain repair information to be omitted. Generally, the computer-generated estimates are not audited, for example, to make sure the materials costs are correct or the right mix of parts is being utilized.

### BRIEF DESCRIPTION OF THE DRAWINGS

FIG. 1 illustrates a vehicle collision estimate audit system network according to an embodiment of the present invention;

FIG. 2 illustrates a vehicle collision estimate audit system according to an embodiment of the present invention;

FIG. 3 illustrates a flowchart of operation of a vehicle collision estimate audit system in single audit mode according to an embodiment of the invention;

FIG. 4 illustrates a flowchart of operation of the vehicle collision estimate system operating in a batch mode according to an embodiment of the present invention;

FIG. 5 illustrates a flowchart of a profile creation according to an embodiment of the invention;

FIG. 6 illustrates an electronic registration screen according to an embodiment of the present invention;

FIG. 7 illustrates a selection screen of the review engine of the vehicle collision estimate audit system according to an embodiment of the present invention;

FIG. 8 illustrates administrative information that may be required for a profile to be completed according to an embodiment of the present invention;

FIG. 9 illustrates a specific line item check input screen for an embodiment of the invention;

FIG. 10 illustrates a line item dependency screen in an embodiment of the present invention;

FIG. 11 illustrates a file management screen according to an embodiment of the present invention; and

FIG. 12 illustrates a multiple file screen according to an embodiment of the present invention.

### DETAILED DESCRIPTION

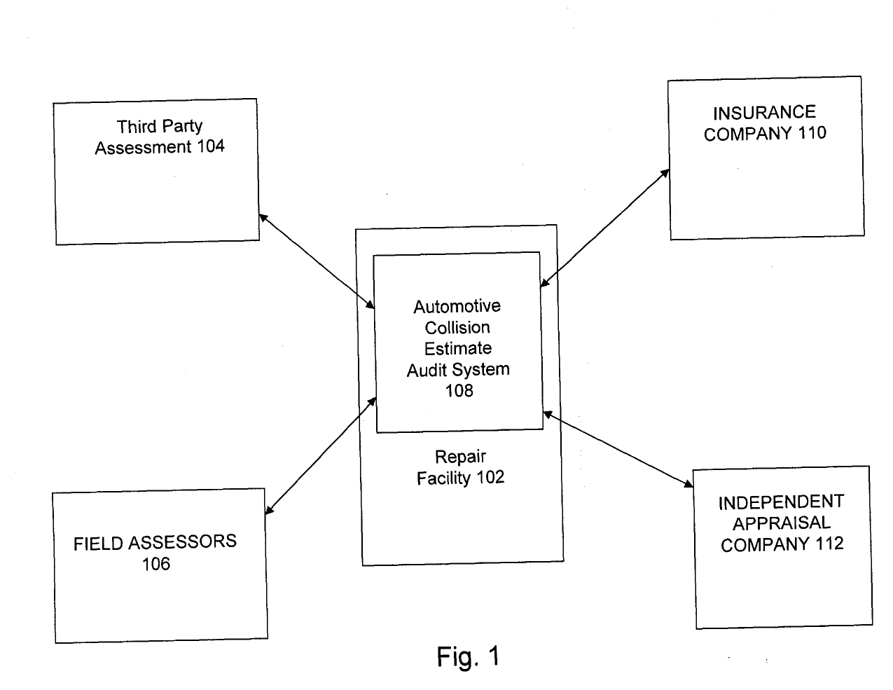

FIG. 1 illustrates a vehicle collision estimate audit system network according to an embodiment of the present invention. The vehicle collision estimate audit system in the vehicle collision estimate audit system network may be utilized by an insurance claims office, by an independent insurance appraiser, by a body shop, or by a repair facility to audit repair estimates to ensure the repair estimates are in conformance with business rules that may be established by insurance company or the repair facilities. The vehicle collision estimate audit system may also identify repair estimates outside a statistical audit range, where the statistical audit range is determined by repair indices which are generated from past paid insurance claim information. In addition, the vehicle collision estimate audit system by identify omitted items on a repair estimate by the use of repair dependencies or line item dependencies.

The vehicle collision estimate audit system network 100 may include a vehicle collision estimate audit system 108. The vehicle collision estimate audit system network 100 may also including computing devices located at an independent appraisal company 112, an insurance company 110, a third party assessment company 104, or out at remote locations with field assessors 106.

The vehicle collision estimate audit system 108 may be located on a computing device at a repair facility 102, as illustrated in FIG. 1. This may allow the vehicle collision estimate audit system 108 to be utilized by the repair facility to make sure that repair estimates created by independent adjusters or appraisers are within acceptable guidelines. The repair facility may also utilize the vehicle collision estimate audit system 108 to verify the accuracy and conformance of repair estimates generated by personnel who work in the repair facility. In an embodiment of the invention, the vehicle collision estimate audit system 108 may be located on a computing device at an insurance company 110 included in the vehicle collision estimate audit system network 100. The insurance company 110 may utilize the vehicle collision estimate audit system 108 to verify the accuracy and conformance of claims submitted from a plurality of repair facilities and independent appraisal companies.

In the embodiment of the invention illustrated in FIG. 1, the vehicle collision estimate audit system 108 may be located at the repair facility 102. The vehicle collision estimate audit system may be coupled to the other locations within the vehicle collision estimate audit system network 100 via a communications network 114. The communications network 114 may be a local area network, a wide area network, or the Internet. In an embodiment of the invention, wireless communications may be used to transmit data, e.g., when a computing device of a field assessor 106 is communicating with an auditing system 108 at the repair facility 102. The communications network 114 should include enough bandwidth to transfer audited estimates, audit information, and photographs to the different locations on the vehicle collision estimate audit system network 100. For example, in the embodiment of the invention illustrated in FIG. 1, the vehicle collision estimate audit system 108 in the repair facility 102 may receive repair estimates and image files from the third party assessment company's computing device 104. The vehicle collision estimate audit system 108 in the repair facility 102 may transmit repair estimates, audited estimates, audit information, and image files to the insurance company's computing device 110, an independent appraisal company device 112 or a third party assessment device 104.

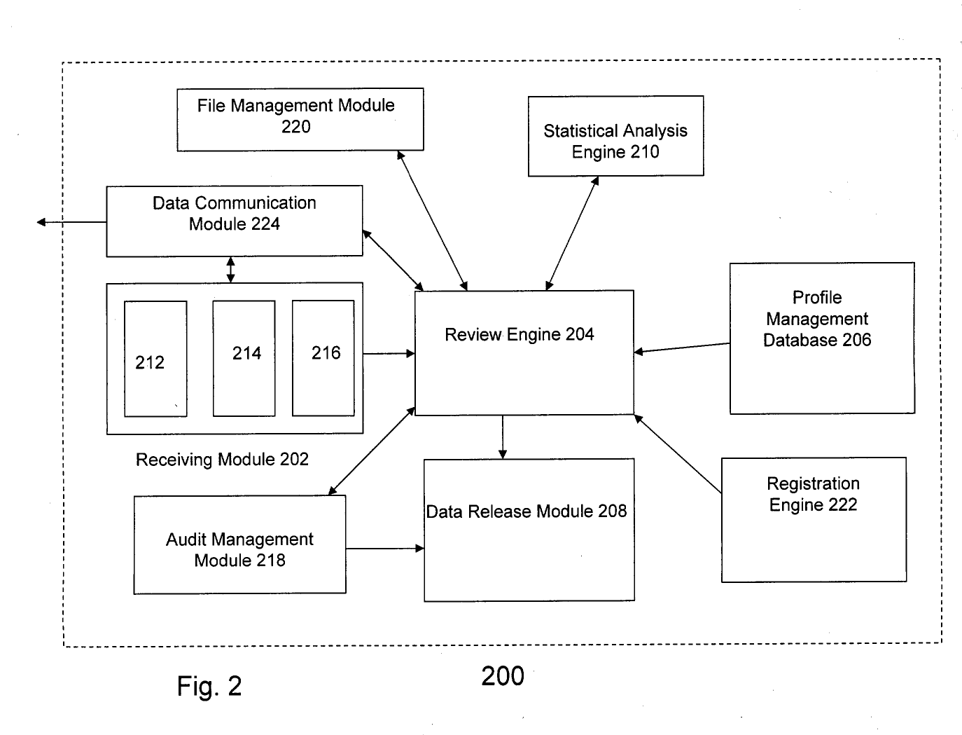

FIG. 2 illustrates a vehicle collision estimate audit system according to an embodiment of the present invention. The vehicle collision estimate audit system 200 may include a receiving module 202 to receive a repair estimate. The vehicle collision estimate audit system 200 may include a review engine 204 coupled to the receiving module 202 to review the repair estimate and to generate an audited repair estimate. The vehicle collision estimate audit system 200 may include a profile management database 206 coupled to the review engine 204 to house at least one business rule to establish at least one processing parameter to review the repair estimate and assist in generating the audited repair estimate. The profile management database 206 may include a plurality of repair dependencies which are utilized to assist in generating the audited repair estimate. The vehicle collision estimate audit system 200 may include a statistical analysis engine 210 which houses a plurality of repair indices where the plurality of repair indices are utilized to assist in generating the audited repair estimate. The vehicle collision estimate audit system 200 may include a data release module 208 coupled to the review engine 204 to receive the audited repair estimate and to provide the audited repair estimate to a shop management system. The data release module 208 may also receive management information regarding the audited repair estimate and the repair estimate, and may output this information to the shop management system.

The statistical analysis engine 210 may include a database housing a plurality of repair indices and software implementing an estimate scoring process. The plurality of repair indices may be generated based upon actual paid insurance claim information. The repair indices may be derived from normalized means and/or standard deviations for gross repair amounts, parts costs, labor content, non-labor parts content, and labor content to parts used to repair automobiles in the past. The estimate scoring process includes calculating a Z-score for each repair indices of the estimate, by using the mean and standard deviation of similar make and model vehicles in the paid claims database. The estimate scoring process also includes summing the Z-scores of repair indices for the estimate, averaging the sum of the Z-scores for the estimate, and comparing the averaged Z-score of the estimate against a defined deviation from normal. If the average of the estimate's indices Z-scores are greater than selected pre-determined values or the defined deviation from normal, then the estimate is internally categorized as a candidate for audit. The estimate scoring process then applies a weighting equation to the pass/fail of each estimate indices to determine if the estimate is flagged for audit.

For example, for Honda Accords the mean gross repair could be $10,000 with a standard deviation of $3,000. To calculate the gross Z-score of an estimate with a gross damage of $11,000, the gross indice would be the estimate gross amount divided by the gross repair indices standard deviation, $11,000/$3,000 or 3.6666666. Because the repair indices are based on a large sample of vehicles, the calculated Z-score of the estimate gross repair is approximately equivalent to the Z-score calculated if the estimate had been added to all vehicles used in the indices and the vehicles Z-score calculated. Estimate Z-scores are calculated in this way for all parameters of the estimate. The sum of the absolute value of the estimate's parameters are averaged to calculate the estimate's average deviation. An allowable deviation is calculated by averaging the sum of the Z-scores deviation selected for each indices. If the estimate's average deviation from norm is greater than the sum of the average Z-scores of the indices selected (tight is an average Z-score of 2, moderate is an average Z-score of 3 and loose is an average Z-score of 4), the estimate is categorized in the statistical analysis engine as an audit candidate. If an estimate is categorized as an audit candidate than a weighting equation is used to determine if the estimate may be flagged for audit.

For example, the weighting equation may be that if an estimate labor indice>=selected labor parameter then Weight=Weight+1. Also, if estimate parts indice>=selected other parameter then Weight=Weight+1. In addition, if estimate other indice>=selected other parameter then Weight=Weight+1. If estimate gross indice>=selected gross, then Weight=Weight+3. Further, if estimate parts/labor indice>=selected parts/labor parameter then Weight=Weight+2. Finally, if vehicle Age>4 year old then Weight=Weight+1. If the calculated weight>=3, then the estimate is flagged for statistical audit.

A database of over 1000 repair vehicles may be used to create the plurality of repair indices. The repair indices may be provided to the review engine 204 and a range may be selected around the repair indices to assist in determining if the repair estimate is in conformance with the repair indices. The database of claims may be continually updated via feeds from other stations on the vehicle collision estimate audit system network 100. For example, a computing device at an insurance company may transmit actual paid claim information to a centralized repository on the network. The central repository may calculate the indices and may consolidate the indices in a single database. The central repository may transmit the updated database of indices to the statistical analysis engine 210 and new repair indices can be calculated based on the updated data. The central repository may be located on any computing device that is part of the vehicle collision estimate audit system network.

In an embodiment of the invention, the receiving module 202 may include an EMS file import module 212. The EMS file import module 212 may receive electronic repair estimates from a variety of repair estimating programs. The EMS file import module 212 may be able to import a plurality electronic repair estimates at a time. The vehicle collision estimate audit system may accept files from a number of industry-established vehicle estimate programs. The files may be received via the EMS file import module 212 and may be stored within the vehicle collision estimate audit system. For example, the files may be generated from a CCC Pathways™ estimating system, a Mitchell's Ultramate™ estimating system, a CompESt™ estimating system, and an ADP Shoplink™ estimating system. Each of the estimating systems generate files in the EMS format and transmit the repair estimate to the EMS file import module 212. In an embodiment of the invention, a co-located estimating system may be located on the same computing device as the vehicle collision estimate audit system and the EMS file import module 212 of the vehicle collision estimate audit system 200 may be configured to automatically receive or receive via operator selection, the repair estimates generated by the co-located estimating system.

In an embodiment of the invention, the receiving module 202 may include a batch audit process module 214. The batch audit process module 214 may operate in an unattended fashion. In other words, a user can configure the batch audit process module 214 of the vehicle collision estimate audit system 200 to receive a plurality of repair estimates automatically. Under certain operating conditions, the automatic operation of the batch operation module may begin at a preset time or when certain other conditions are met. Under certain operating conditions, the batch audit may be started manually, e.g., through selection within the batch audit process module 214. An operator of the vehicle collision estimate audit system 200 may select a directory that includes a plurality of repair estimates. The operator may identify profiles based on the mapping of the profiles to insurance companies that are identified in the estimate data. The batch audit process module 214 may then be started and a plurality of audited repair estimates may be generated.

The receiving module 202 may also include a single audit module 216. The single audit module 216 may be configured to select a single repair estimate. The operator may also select a profile to be applied against the estimate. The operator may then select to start processing the repair estimate. When the processing is started, the single audit module 216 may transmit the repair estimate to the review engine 204.

The profile management database 206 may be coupled to the review engine 204 to provide a profile for the repair estimate currently being processed. A plurality of profiles may be stored within the profile management database 206. Each profile may include at least one business rule. The business rule(s) may identify certain logic that is to be applied against the information included in the repair estimate. The business rules are created by establishing parameters that are included in the estimate and identifying ranges or thresholds, i.e., limits, for the parameters.

An organization may establish a profile for repair estimates that it has responsibility for paying. For example, an insurance company may decide that certain parameters must be in line for any repair estimates that they are responsible to pay. A profile may also be established by a repair facility to ensure they are operating efficiently and preparing repair estimates in conformance with the multiple insurance companies the repair facility interacts with. The profile may also allow the organization to ensure that required administrative information is included within the estimate before it is transmitted to the organization. For example, this may allow for faster payment to a repair facility by an insurance company because of faster processing time. Illustratively, an insurance company may include information in the profiles to ensure that the required insurance information is included in the audited repair estimate transmitted to the insurance company.

Generally, the parameters established by the profile may fall into a number of categories. For example, the parameters may be general parameters, administrative parameters, repair parameters, refinish parameters, or repair dependency parameters. General parameters may refer to limits on labor rates, whether or not an operator can override certain amounts, when non-original equipment manufacturer (OEM) parts may be utilized, and what range is set for the standard deviation (moderate, loose and tight) for the different statistical checks. Administrative parameters may refer to 1) identifying what administration information is to be in the estimate, 2) whether duplicate entries should be reported, 3) whether to report betterment and Like, Kind, and Quality (LKQ) usage, and 4) when to warn for maximum paint charges.

Repair parameters may refer to the check of specific items within the estimate, whether the specific items are within a maximum and minimum charge range, and whether items are required to be on an estimate. The repair parameters also refer to establishing what type of parts may be used in making the repair (new, used, aftermarket, etc.). In addition, the repair parameters may establish when betterment is applied for certain selected items. Betterment may be defined as a depreciation value that is established for a part.

The profiles may also be established with repair dependency parameters. A repair dependency parameter is established for a specific item that identifies that other items should also be included with the specific item. This feature allows the operator to ensure that associated and commonly missed or forgotten items are on the automotive collisions repair estimate. For example, if one part needs to be replaced when another part is replaced, a dependency parameter may be established between the two parts. A repair dependency consists of not only the repair item but the operation being performed, i.e., if a headlight is replaced, then a Check/Adjust headlight operation must be performed.

The vehicle collision estimate audit system 200 may include an audit management module 218. The audit management module 218 may receive management data generated by the review engine 204 and may create management reporting files. The management reporting files may be used to create management reports that reflect the audit activity of the vehicle collision estimate audit system 200. Repair facilities utilize the files to identify repair operations and items that were unintentionally omitted from estimates but were included in the repair process and paid for by the repair facility by estimator, vehicle and insurance company. This allows repair facilities to evaluate the relative performance of estimators in their facility, identify the estimators' degree of accuracy in estimating different makes and models of vehicles, and quantify the estimators' degree of compliance of various insurance company partners. Insurance companies may aggregate information to evaluate the relative compliance of repair facilities to their repair practices and policies. The management reporting files may be collected in the audit management module 218 or may be transmitted to the data release module 208 or data communication module 224.

The vehicle collision estimate audit system 200 may include a file management module 220. The file management module 220 may allow an operator to identify where the vehicle collision estimate audit system 200 exports the audited automotive collision estimates. The file management module 220 may allow an operator to identify where to write management reporting information. The file management module 220 may allow an operator to identify where to write the audited automotive collision estimates. The file management module 220 may allow the operator to identify where to write automotive collision estimates or audited automotive collision estimates for archival purposes. In addition, the file management module 220 may allow the operator to delete either repair estimates or audited repair estimates.

The vehicle collision estimate audit system may include a data communications module 224. The data communications module 224 may be coupled to receiving module 202 and the review engine 204. The data communications module 224 may transmit the audited repair estimate(s), images associated with the repair estimate(s), and other associated information to any computing device on the vehicle collision estimate audit system network. The data communications module 224 may transmit this information over a communications network, e.g., the Internet. The data communications module 224 may encrypt the repair estimate(s), images, and other associated information utilizing, for example, 256-bit encryption. For example, a body shop may transmit the repair estimate(s), images associated with the repair estimate and other information to an insurance company. In an embodiment of the invention, the review engine 204 may provide the data communication module 224 with the audited repair estimate(s). The data communication module 224 may receive other information regarding the repair estimate(s) from the receiving module. In an embodiment of the invention where the audited repair estimates and associated data are stored in the receiving module 202 or on the computing device housing the vehicle collision estimate audit system, the file management module 220 may select the audited repair estimate(s) and associated data and transfer the audited repair estimate(s) and associated data to the data communication module 224.

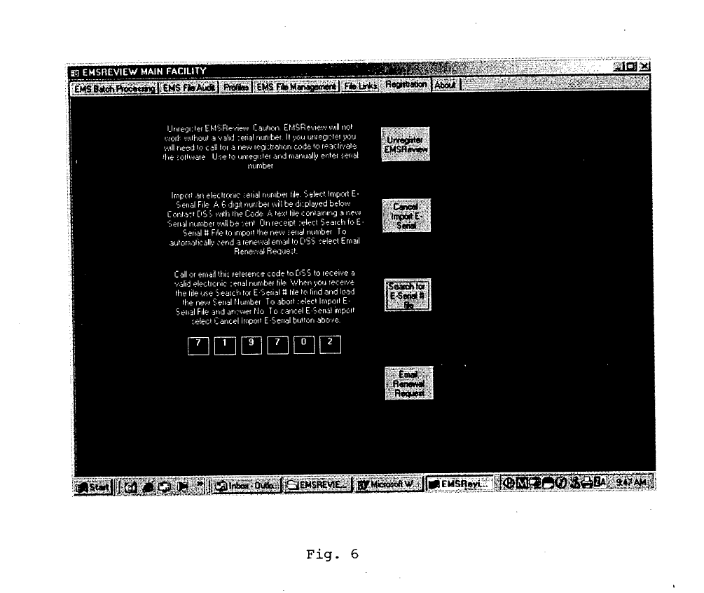

The vehicle collision estimate audit system may include a registration engine 222. The registration engine 222 controls what features of the product are available to the user. The registration engine 222 also controls for what time period a user may utilize the automotive collision estimate system 200. The registration engine 222 may instruct the vehicle collision estimate audit system to notify the user that the registration serial number may expire in a certain timeframe. If a new registration serial number is required, a user may obtain the new registration serial number by email or via the telephone. FIG. 6 illustrates an electronic registration screen according to an embodiment of the present invention. The registration engine 222 may be configured to transmit an email renewal request with contact information in a time frame before a registration is to expire. A centralized registration server located at automotive collision estimate audit system's creator's headquarters, e.g., Decision Support Services, may verify the current status of the license of the automotive collision estimate audit system. If the license is verified, i.e., the license has been paid, a registration serial number may be transmitted to the email identified in the contact information. This registration number may be utilized to continue to operate the vehicle collision estimate audit system.

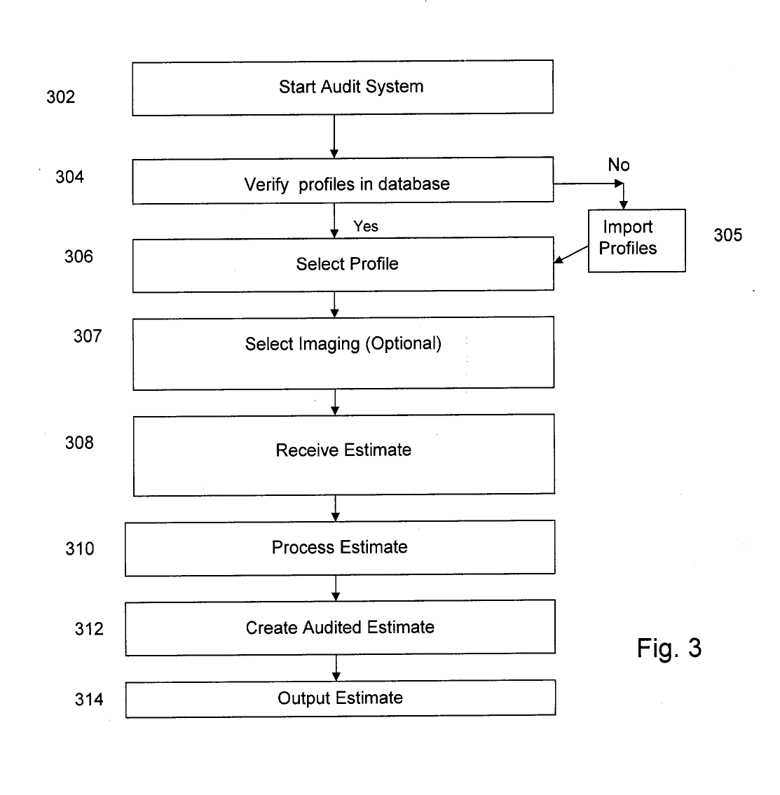

FIG. 3 illustrates a flowchart of operation of the vehicle collision estimate audit system in single audit mode according to an embodiment of the invention. The vehicle collision estimate audit system may be started or opened 302. The review engine 204 (see FIG. 2) may verify 304 that the plurality of profiles are located in the profile management database 206 (see FIG. 2). If the plurality of profiles are not located in the profile management database 206, then the review engine 204 import 305 profiles into the vehicle collision repair estimate audit system 200 or profile(s) via the receiving module 202. Alternatively, the vehicle collision estimate audit system may allow the creation of a new profile and the new profile may be stored in the repair management database 206. The review engine 204 may select 306 the profile to be utilized. The review engine 204 may select 307 imaging enablement if imaging should be enabled for the profile to be utilized, i.e., image files for the repair estimate may be attached to the repair estimate.

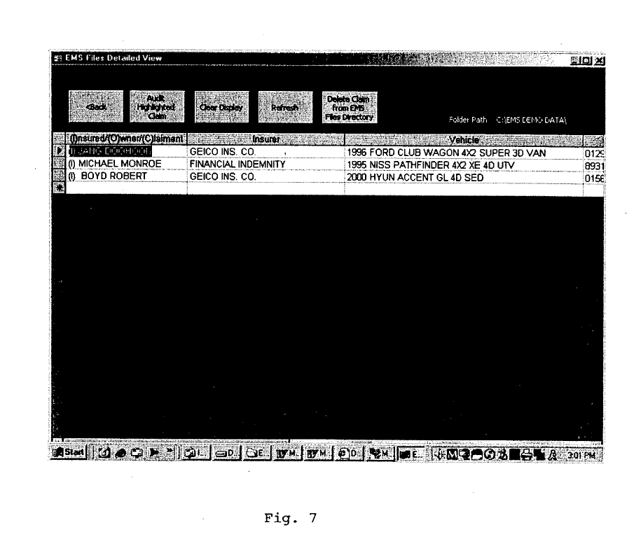

An estimate may be received 308 by the receiving module 202. The review engine 204 may receive the estimate from the receiving module 202 and the review engine 204 may process 310 the estimate. FIG. 7 illustrates a selection screen of the review engine of the vehicle collision estimate audit system according to an embodiment of the present invention. In this embodiment of the invention, the operator may select from a list of estimates identified by the fields of Insured, Vehicle, Insurance Company, and file ID. The review engine creates 312 an audited repair estimate. The review engine utilizes an associated profile from the profile management database to assist in preparing the audited repair estimate. The profile management database provides business rule(s), line item dependencies, and a statistical audit range for repair indices included in the profile to the review engine. The review engine outputs 314 the audited repair estimate to the data release module 208.

In an embodiment of the invention, the data release module 208 may transmit the audited repair estimate to a repair facility management system.

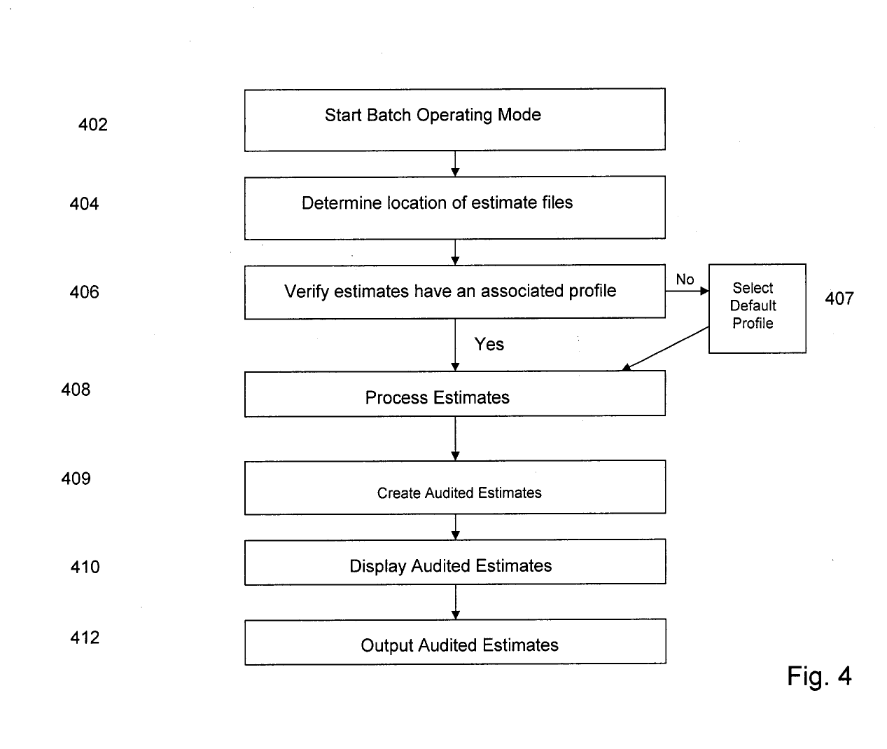

FIG. 4 illustrates a flowchart of operation of the vehicle collision estimate audit system operating in a batch mode according to an embodiment of the present invention. The batch operating mode may be enabled or started 402 via the batch audit process module 214. The batch audit process module 214 may determine 404 the location within the vehicle collision estimate audit system of the repair estimate files. The review engine 204 may verify 406 that all the repair estimates within the batch file(s) have an associated profile. The review engine 204 may select 407 a default profile for all repair estimates without an associated profile. Illustratively, the default profile may also be utilized for walk-ins to the repair facility. The review engine 204 may start the batch audit module and the repair estimates may be processed 408. The review engine 204 may create 409 audited repair estimates. The review engine utilizes an associated profile from the profile management database to assist in preparing the audited repair estimates. The profile management database provides business rule(s), line item dependencies, and a statistical audit range for repair indices included in the profile to the review engine. After the batch audit processing has been completed, the review engine 204 may display 410 any audited estimate for detailed viewing. The review engine 204 may transmit 412 audited repair estimates, the original repair estimates, and system management information to the data release module 208.

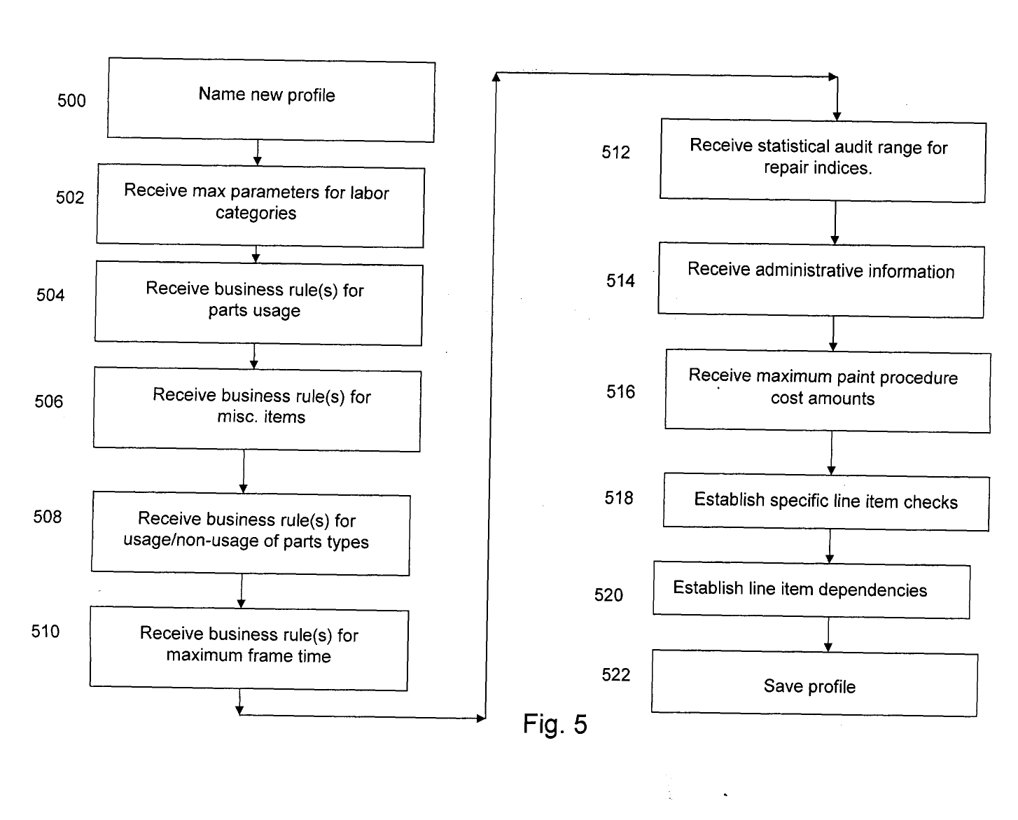

FIG. 5 illustrates a flowchart of a profile creation according to an embodiment of the invention. The profile management database 206 may receive 500 a name for a new profile. The profile management database 206 may receive 502 a maximum parameter for a number of categories of labor for the new profile. Illustratively, the maximum parameter may be a labor rate amount. For example, a maximum labor rate may be established for body work, frame work, refresh work, glass work, mechanical work, and body—structural work. If this rate is exceeded, the vehicle collision estimate audit system may generate a warning. The profile management database 206 may receive 504 at least one business rule for parts usage for the new profile. Under certain operating conditions, the profile management database may receive a plurality of business rules for parts usage. For example, a maximum percentage of OEM parts dollars or a minimum percentage of non-OEM parts dollars may be input to create business rules that are to be utilized in repair estimate. The profile management database 206 may also receive input identifying whether the parts percentages established in the business rules may be based on the total repair estimate or only on the total parts dollars.

The profile management database 206 may also receive 506 input to establish business rules for miscellaneous tasks for the new profile. For example, the profile management database may receive as input a vehicle age business rule that identifies the age of a car that may generate an error message in the automotive repair estimate audit system. The profile management database 206 may also receive input for a business rule to identify a maximum amount of materials that may be utilized in the repair estimate. In addition, the profile management database 206 may receive input for a business rule to identify a maximum amount of manual parts dollars to be utilized in the estimate. The profile management database 206 may receive input for a business rule to identify a maximum amount of manually entered labor hours.

The profile management database 206 may also receive 508 input for business rules for identifying the usage/non-usage of part types for the new profile. For example, the profile management database 206 may receive input for a business rule that identifies whether or not LKQ parts should be considered in the repair estimate. The usage of LKQ parts may be determined based on the age of the car and the mileage value of the car. Another example of a parts type business rule is the profile management database 206 receiving input identifying whether or not aftermarket parts may be considered for the estimate. The usage of aftermarket parts may be determined based on the age of the car and the mileage value of the car.

The repair management database 206 may also receive 510 input for a business rule establishing a maximum frame time for the new profile. For example, the repair management database 206 may receive input for a maximum amount of hours to be spent on frame repair. If this amount is exceeded, the automotive collision estimate audit system may generate an error message.

The repair management database 206 may receive 512 input to identify a statistical audit range for specific parameters, i.e., repair indices, based on past claims data. The statistical audit range may be utilized for the repair indices which are resident in the statistical analysis engine 210. The repair management database 206 may receive input identifying which of the repair indices are to be utilized for the new profile. A representative, but not limiting, example of repair indices includes gross repair amounts, parts costs, labor content in terms of dollar cost and hours, non-labor/parts content, and labor content utilized on parts. For example, the repair management database 206 may receive input identifying a numerical range of allowable deviations or identifying a default numerical range, e.g., 2.000, 4.000, 3.000, for the repair indices when the new profile is being utilized. During the audit process, the repair estimate parameters are calculated for each indice and may be compared to the repair indices to identify if the estimate is within the statistical audit range. If the repair estimate is outside the range then a weighting system is used to perform final classification of the estimate. The vehicle collision estimate audit system may generate a warning message if the repair estimate being reviewed varies from the established repair indices by greater that the statistical audit range and the weight threshold is exceeded. For example, in the statistical analysis engine 210, an estimate involving a 2001 Nissan Infiniti which needs to have a right fender replaced and repainted will be compared against vehicle indices for similar makes and models. Illustratively, the similar makes and models have a gross mean repair indice of $7,000 with a standard deviation of $2000, a labor mean repair indice of $3900 with a standard deviation of $2000, and a parts means repair indice of $3000 with a standard deviation of $1500. The new profile created in the profile management database 206 may utilize these repair indices to determine if the repair lies within normal bounds for repairs done on similar vehicle makes and models. If the profile management database 206 receives input identifying that the statistical average of the estimates Z-scores are greater than the average Z-scores selected and the weighting equation categorized the estimate audit is greater than an established threshold, then the vehicle collision estimate audit system may generate a warning message to alert that the estimate cost is not within the statistical audit range and an error might have been made.

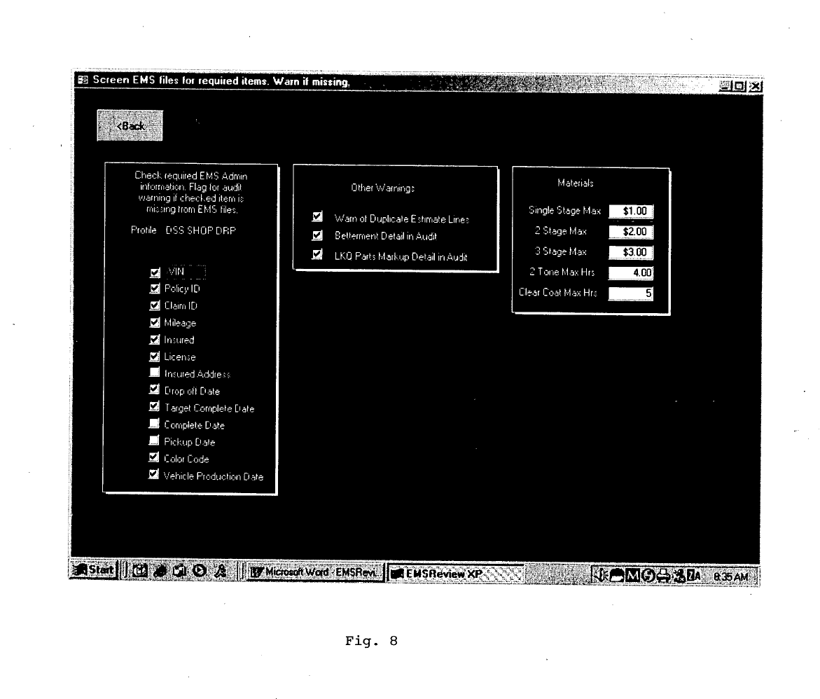

The profile management database 206 may receive 514 administrative information that is required to be included with each repair estimate associated with or mapped to the new profile. If the administrative information is missing, the vehicle collision estimate audit system may generate a warning message requesting that an identified field be completed. FIG. 8 illustrates administrative information that may be required for a profile to be completed according to an embodiment of the present invention. For example, the system may require the vehicle identification number (VIN), an insurance policy ID, an accident claim ID, the mileage of the car, the driver's license number, etc.

The profile management database 206 may receive 516 input identifying maximum paint procedure cost amounts for the new profile. For example, the profile management database 206 may receive input identifying a maximum cost for a paint first stage, a paint second stage, a paint third stage, a paint two-tone stage, and a paint clear-coat stage.

The profile management database 206 may receive 518 input to establish specific line item checks for the new profile. A line item is text that the vehicle collision estimate audit system may check for in the selected or group of selected repair estimates. The specific line item check may be established to require that the text matches exactly. Under other operating conditions, the specific line item check may be established to require that the text is similar to the specific line item. Illustratively, may only a portion of the description for a specific line item may need to be matched. For example, the specific line item check may require that the text “corrosion protect” is in the specific line item. Thus, if the specific line item text in the repair estimate is “corrosion protection”, a match would be identified. The specific line item check may also identify multiple match possibilities for the specific line items. For example, the specific line item check could identify that the text “2 wheel” or “two wheel” in an estimate is similar to the specific line item 2 wheel alignment.

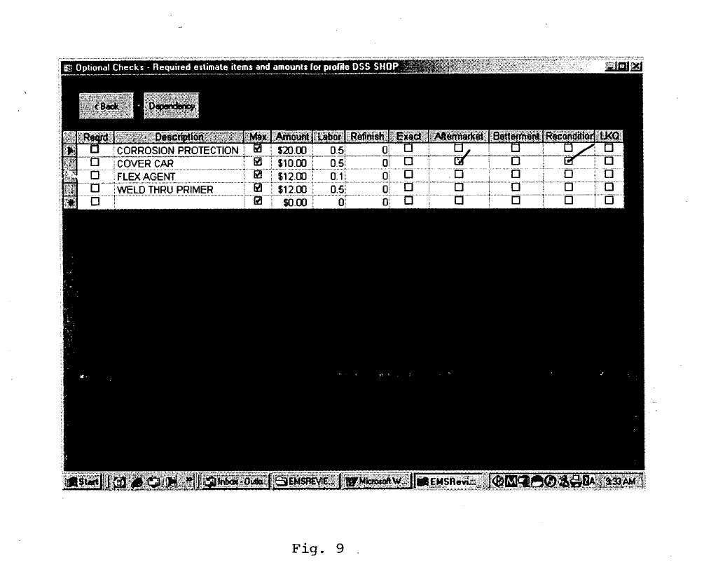

FIG. 9 illustrates a specific line item check input screen for an embodiment of the invention. If a specific line item must be in every repair estimate associated with this profile, then the operator may choose a required field for the specific line item. The operator may input text in a description field. The description field may provide the text string that is utilize to compare against text strings in the estimate. A threshold cost field may be input. The threshold cost field may be utilized to establish minimum cost for the specific line item. The threshold cost field may also be utilized to establish a maximum cost for the specific line item. FIG. 9 illustrates the utilization of the threshold cost field as a maximum cost for the specific line item, e.g., corrosion protection, cover car, flex agent, etc. A labor field may be input to establish the maximum (or minimum) amount of labor hours for the specific line item. A refinish field may be input to establish the maximum (or minimum) amount of labor hours spent on refinish for the specific line item. Selected part types may be input for the specific line item. For example, the part types that are available to be selected are aftermarket parts, betterment, reconditioned, or LKQ parts. If a part type is selected, this type of part may always be selected for this specific line item. For example, aftermarket or reconditioned parts may always be considered when the specific line item is brake pad replacement.

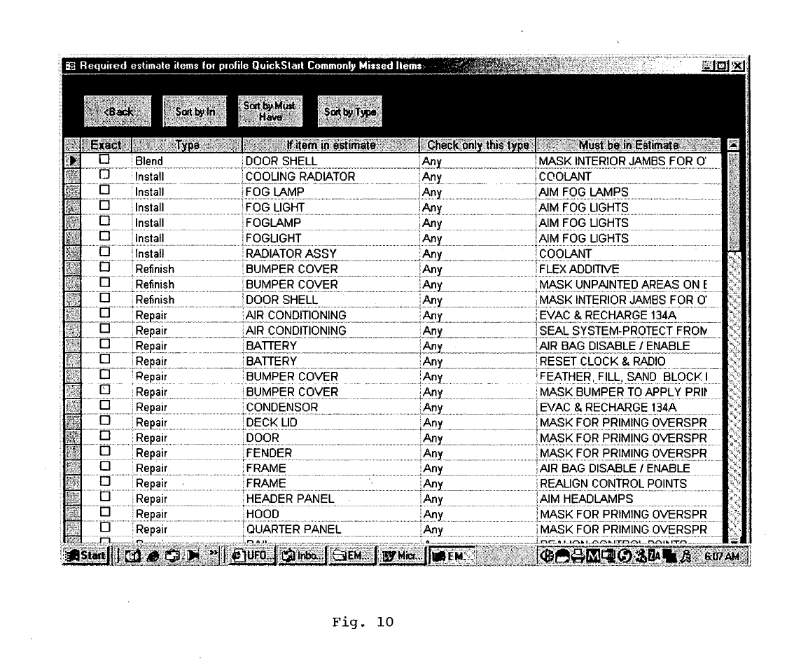

The profile management database may receive input 520 to establish line item dependencies. Line item dependencies are items that must be completed along with a line item that is included in the estimate. In other words, if the line item is included in an estimate, any additional item defined as a line item dependency for that line item must also be included in the repair estimate. FIG. 10 illustrates a line item dependency screen in an embodiment of the present invention. Illustratively, if a bumper cover is replaced, then the system identifies that a flex additive must be included in the estimate along with a labor entry for performing a task of masking unpainted areas on the bumper.

The profile management database 206 may save 522 the new profile.

The computer automotive estimate audit system may allow the cloning or copying of profiles. The profile management database 206 may receive input identifying a name of a new profile, receive input identifying the old profile, select the old profile and may copy the contents of the old profile into the new profile. After the contents of the old profile have been copied, the profile management database 206 may save the cloned profile.

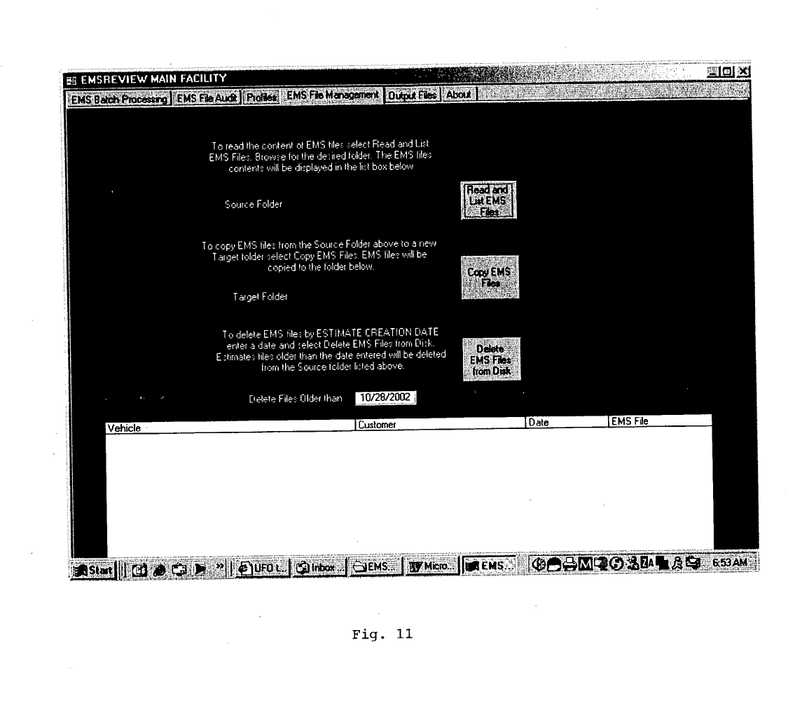

The vehicle collision estimate audit system may allow easy file management. FIG. 11 illustrates a file management screen according to an embodiment of the present invention. Illustratively, the file management module 220 can provide which repair estimate files are available in a given directory. The file management module 220 may be configured to open a repair estimate file once the repair estimate file is selected. The file management module 220 may receive input to create a backup of the repair estimate files. The file management module 220 may receive input to select the location where the repair estimate files are to be copied. The file management module 220 may receive input to delete selected repair estimate files. Selected repair estimate files may be deleted or repair estimate files that were created prior to a selected date may be deleted.

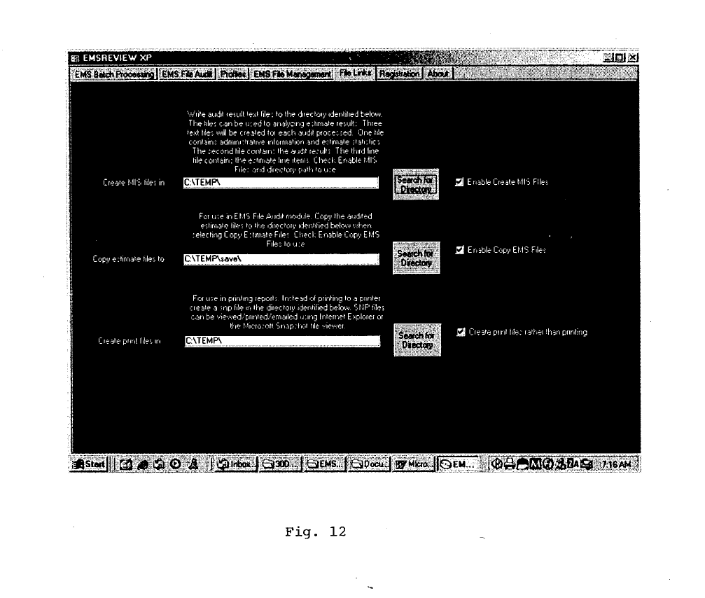

The vehicle collision estimate audit system may create a plurality of files each time an audit of an estimate occurs. FIG. 12 illustrates a multiple file screen according to an embodiment of the present invention. Illustratively, the file management module 220 may create a first file including administrative information and estimate statistics. The file management module 220 may create a second file including the audit results. The file management module may also create a third file including the estimate line items.

The automotive collision estimate audit system may be configured to copy the audited estimate files to a specific directory. FIG. 12 illustrates an input screen to identify where the audited estimate files should be copied to.

The file management module 220 of the vehicle collision estimate audit system may be configured to create audit results or an estimate printout in a file format, rather than sending the audit result or the estimate printout to a printer. FIG. 12 illustrates an input screen to identify where the files may be stored once they are created. In an embodiment of the present invention, the audit results or estimate printout may be viewed utilizing the Microsoft Snap Viewer or Microsoft Internet Explorer.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A vehicle collision estimate audit system, comprising:
a receiving module to receive an a repair estimate;
a review engine coupled to the receiving module to review the repair estimate and to generate an audited repair estimate;
a profile management database coupled to the review engine to house at least one profile, the one profile being associated with the repair estimate, and utilized to assist in generating the audited repair estimate; and
a data release module coupled to the review engine to receive the audited repair estimate and to output the audited repair estimate.

2. The system of claim 1, wherein the at least one profile includes at least one business rule and the at least one business rule is utilized to monitor a parameter in the repair estimate and to identify if the repair estimate is within limits established by the at least one business rule.

3. The system of claim 1, wherein the repair estimate includes at least one line item, the at least one profile associated with the at least one line item includes specific line item checks and the specific line item checks monitor whether the repair estimate operates within limits or parameters established by the specific line item checks.

4. The system of claim 3, wherein the at least one profile further includes line item dependencies and the line item dependencies monitor whether other line items, which are required to be included with the at least one line item, are included within the repair estimate.

5. The system of claim 1, further including:
a statistical analysis engine coupled to the review engine to utilize a database of repair indices derived from paid insurance claim information to assist the review engine in auditing the repair estimate.

6. The system of claim 5, wherein the repair indices are associated with the at least one profile and the repair indices are utilized to ensure the repair estimate associated with the at least one profile is operating within a statistical audit range.

7. The system of claim 1, further including a registration engine to verify that a license for the automotive collision estimate audit system is paid.

8. The system of claim 1, wherein the receiving module operates in a batch mode to automatically process the repair estimates.

9. The system of claim 1, further including an audit management module coupled to the review engine to provide system management information from the audited repair estimate.

10. The system of claim 1, further including a file import module coupled to the review engine to receive a repair estimate file from an external computing device and to transmit the repair estimate from the repair estimate file to the review engine 204.

11. The system of claim 1, further including a file management module to allow a user to identify where the audited estimate files and the management report files are to be stored.

12. The system of claim 1, further including a data communications module, coupled to the review engine, to transmit the audited repair estimate and an associated image to an external computing device via a communication network.
